(19) United States
(12) Patent Application Publication
(10) Pub. No.: US 2026/0030257 A1
(43) Pub. Date: Jan. 29, 2026

(54) System and Method of Device Performance and Behavior Tracking and Analysis

(71) Applicant: Cox Communications, Inc., Atlanta, GA (US)

(72) Inventors: Matan Becker, Atlanta, GA (US); Judy Brown, Atlanta, GA (US)

(21) Appl. No.: 19/281,166

(22) Filed: Jul. 25, 2025

Related U.S. Application Data
(60) Provisional application No. 63/675,604, filed on Jul. 25, 2024.

(51) Int. Cl. G06F 16/25; G06F 16/26

(52) U.S. Cl. CPC G06F 16/254; G06F 16/26

(57) ABSTRACT

An example system includes a set of servers configured to store a plurality of equipment lifecycle datasets, a display, and a visualization server in operable communication with the plurality of servers and the display, where the visualization server comprises a processor and a non-transitory memory storing instructions, that, when executed, cause the processor to: receive the plurality of equipment lifecycle datasets from the plurality of servers; automatically extract, from the plurality of equipment lifecycle datasets, a visualization dataset; and output the visualization dataset for display.

### CROSS-REFERENCE TO RELATED APPLICATIONS

This application claims the benefit of U.S. provisional patent application No. 63/675,604, filed on Jul. 25, 2024, and titled “SYSTEM AND METHOD OF DEVICE PERFORMANCE AND BEHAVIOR TRACKING AND ANALYSIS,” the disclosure of which is expressly incorporated herein by reference in its entirety.

### BACKGROUND

Improvements to computer systems have led to substantial increases in data collection. For example, the digitization of records and increased use of digital sensors have created orders of magnitude more digital data than was available previously. Such data is often distributed across many systems and devices, and therefore not directly useful. Systems and methods for combining, analyzing, and visualizing data therefore improve the use of distributed data.

### SUMMARY

Implementations of the present disclosure include a set of servers storing equipment lifecycle datasets, a display, and a visualization server. The visualization server receives the datasets from the set of servers, automatically extracts a visualization dataset using machine learning models, and outputs it for display. The system can calculate device lifecycle utilization and cost based on historical usage and repair data, providing real-time insights into equipment performance.

In some aspects, implementations of the present disclosure include a system including: a plurality of servers configured to store a plurality of equipment lifecycle datasets; a display; and a visualization server in operable communication with the plurality of servers and the display, wherein the visualization server includes a processor and a non-transitory memory storing instructions, that, when executed, cause the processor to: receive the plurality of equipment lifecycle datasets from the plurality of servers; automatically extract, from the plurality of equipment lifecycle datasets, a visualization dataset; and output the visualization dataset for display by the display.

In some aspects, implementations of the present disclosure include a system, wherein the non-transitory memory further includes a trained machine learning model.

In some aspects, implementations of the present disclosure include a system, wherein the equipment lifecycle datasets include purchasing data, deployment data, and repair data for a set of equipment under analysis.

In some aspects, implementations of the present disclosure include a system, wherein the machine learning model is a time-series forecasting model.

In some aspects, implementations of the present disclosure include a system, wherein the visualization dataset includes an output of a trained machine learning model.

In some aspects, implementations of the present disclosure include a system, wherein the visualization dataset includes an estimate of lifecycle utilization.

In some aspects, implementations of the present disclosure include a system, wherein the visualization dataset includes an estimate of lifecycle cost of ownership.

In some aspects, implementations of the present disclosure include a computer-implemented method including: receiving a plurality of equipment lifecycle datasets from a plurality of servers; automatically extracting, from the plurality of equipment lifecycle datasets, a visualization dataset; and outputting the visualization dataset for display by the display.

In some aspects, implementations of the present disclosure include a computer-implemented method, wherein automatically extracting the visualization dataset includes inputting the plurality of equipment lifecycle datasets into a trained machine learning model.

In some aspects, implementations of the present disclosure include a computer-implemented method, wherein the visualization dataset includes an output of a trained machine learning model.

In some aspects, implementations of the present disclosure include a computer-implemented method, wherein the trained machine learning model is a time-series forecasting model.

In some aspects, implementations of the present disclosure include a computer-implemented method, wherein the equipment lifecycle datasets include purchasing data, deployment data, and repair data for a set of equipment under analysis.

In some aspects, implementations of the present disclosure include a computer-implemented method, wherein the visualization dataset includes an estimate of lifecycle utilization.

In some aspects, implementations of the present disclosure include a computer-implemented method, wherein the visualization dataset includes an estimate of lifecycle cost of ownership.

In some aspects, implementations of the present disclosure include a non-transitory computer-readable medium storing instructions thereon, that, when executed by a processor, cause the processor to: receive a plurality of equipment lifecycle datasets from a plurality of servers; automatically extract, from the plurality of equipment lifecycle datasets, a visualization dataset; and output the visualization dataset for display by the display.

In some aspects, implementations of the present disclosure include a non-transitory computer-readable medium, wherein the non-transitory computer readable medium further includes instructions that, when executed by the processor, cause the processor to input the plurality of equipment lifecycle datasets into a trained machine learning model.

In some aspects, implementations of the present disclosure include a non-transitory computer-readable medium, wherein the visualization dataset includes an output of the trained machine learning model.

In some aspects, implementations of the present disclosure include a non-transitory computer-readable medium, wherein the trained machine learning model is a time-series forecasting model.

In some aspects, implementations of the present disclosure include a non-transitory computer-readable medium, wherein the equipment lifecycle datasets include purchasing data, deployment data, and repair data for a set of equipment under analysis.

In some aspects, implementations of the present disclosure include a non-transitory computer-readable medium, wherein the visualization dataset includes an estimate of lifecycle utilization or lifecycle cost of ownership.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a method of data visualization according to implementations of the present disclosure.

FIG. 2 illustrates a system for data processing and visualization, according to implementations of the present disclosure.

FIG. 3 illustrates an example data visualization, according to implementations of the present disclosure.

FIG. 4 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for lifecycle analytics of customer equipment, it will become evident to those skilled in the art that the implementations described herein are not limited thereto, but are applicable for collecting and visualizing data from any process.

As used herein, the terms “about” or “approximately” when referring to a measurable value such as an amount, a percentage, and the like, is meant to encompass variations of +20%, +10%, +5%, or +1% from the measurable value.

Large scale service and manufacturing operations face significant challenges in data collection and processing. Legacy systems often result in data being located in different physical and/or virtual locations (e.g., different physical or virtual servers). As a result, no single source of data can provide a complete dataset to support taking action. For example, determining the cost of ownership for a piece of equipment may involve synthesizing data across multiple datasets to account for the original cost of the equipment, the cost of repairing the equipment, the cost of installing the equipment, the cost of maintaining the equipment, and the cost of storing the equipment. These lifecycle costs can be recorded separately across different systems and servers, so that no one server stores the cost of ownership of the equipment. Similarly, data that relates to the reliability of equipment can be split across multiple servers, preventing any one server from being used to predict the failure rate of the equipment.

Implementations of the present disclosure enable improved predictions and analytics by automatically combining data sources across various environments (e.g., various physical and virtual servers and/or cloud servers). Conventional systems can accomplish these analytics and predictions by manually querying separate databases and performing the laborious step of harmonizing data from different sources. Implementations of the present disclosure therefore overcome limitations of conventional systems which require manual queries and therefore provide technical improvements in the speed and accuracy of generating data visualizations and predictions. Thus, implementations of the present disclosure enable the analysis of large portfolios of devices that would be impractical to accomplish using conventional manual data querying and processing techniques.

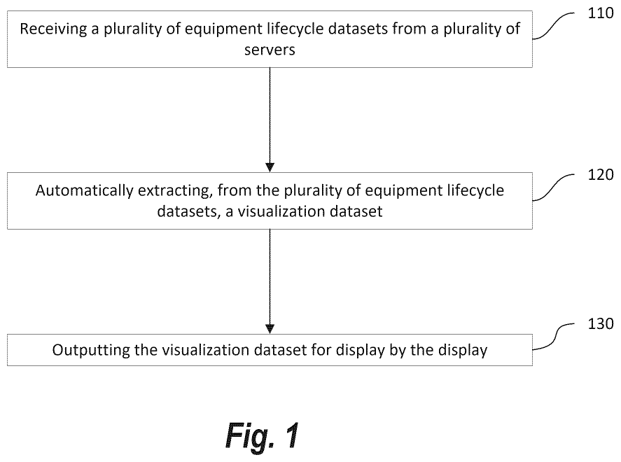

With reference to FIG. 1, an example computer-implemented method is shown according to implementations of the present disclosure.

At step 110, the computer-implemented method includes receiving a set of equipment lifecycle datasets from a plurality of servers. As used herein, a lifecycle dataset can include any information collected over the lifecycle of a piece of equipment. Non-limiting examples of lifecycle data can include purchasing data, historical usage data, maintenance data, deployment data, and/or repair data.

At step 120, the computer-implemented method includes automatically extracting, from the set of equipment lifecycle datasets, a visualization dataset. Optionally, step 120 can include using a trained machine learning model to detect anomalies and/or make predictions based on the set of equipment lifecycle datasets. The set of equipment lifecycle datasets can be input into the trained machine learning model, and the trained machine learning model can be configured to output detected anomalies, and/or predictions for display.

In an example implementation, automated SQL queries can be used to synthesize the visualization dataset from any number of sources. The visualization dataset can then be queried to output any or all of the visualization dataset for display.

In some implementations, the trained machine learning model is a time-series forecasting model. A non-limiting example of a time-series forecasting model that can be used is the “Prophet” forecasting model (“FBPROPHET”). The time-series forecasting model can be trained on historical data (e.g., one year of historical data, five years of historical data, etc.). The historical data can represent any combination of the lifecycle data described herein. Optionally, the time-series forecasting model can be retrained iteratively (e.g., weekly, monthly, yearly) using new data. Optionally, the retraining is performed using mapgrid hyperparameter tuning.

The time-series forecasting model (e.g., FBPROPHET) can be trained on historical data to predict future equipment performance. The time-series forecasting model can be configured to predict future key performance indicators (KPIs) of the equipment lifecycle datasets. Any number or combination of KPIs can be forecasted, and the present disclosure contemplates that the user can optionally configure the tracked KPIs.

An anomaly detection model can be built off this forecasting model to detect anomalies in real-time or near-real-time, such as a sudden increase in failure rates for specific components. The anomaly detection methods described herein can optionally use statistical and/or machine learning techniques to detect outliers and anomalies in the predicted data. This allows operators to quickly identify and address potential issues before they become major problems. Optionally, the anomaly detection can include using Z-score values to represent different levels of anomalies. As a non-limiting example, a Z-score value of 2 and a Z-score value of 3 can represent different levels of anomalies.

Optionally, the anomaly detection model can be configured to detect anomalies in operation in real-time or near-real-time. For example, a sudden increase in the failure rate of one or more components of a cable modem can be identified in real-time or near real-time.

Optionally, the anomaly detection model can be configured to monitor anomalies in any number or combination of the equipment lifecycle datasets. For example, each equipment lifecycle dataset can be represented by one or more KPIs and an upper and lower anomaly band can be calculated for each KPI. As a non-limiting example, the following formulas can be used to determine the upper and lower anomaly bands:

Upper Anomaly Band (UAB)=Predicted Value+(σ*Z-score)

Lower Anomaly Band (LAB)=Predicted Value−(σ*Z-score)

where σ is the standard deviation of the historical data, and Z-score can be either 2 or 3 to represent different levels of anomalies.

Optionally, values of the KPIs that are outside the UAB and/or LAB can be identified as anomalies and/or output for display.

The visualization dataset can include any information about the equipment lifecycle. For example, the visualization dataset can include an estimate of lifecycle utilization or cost of ownership.

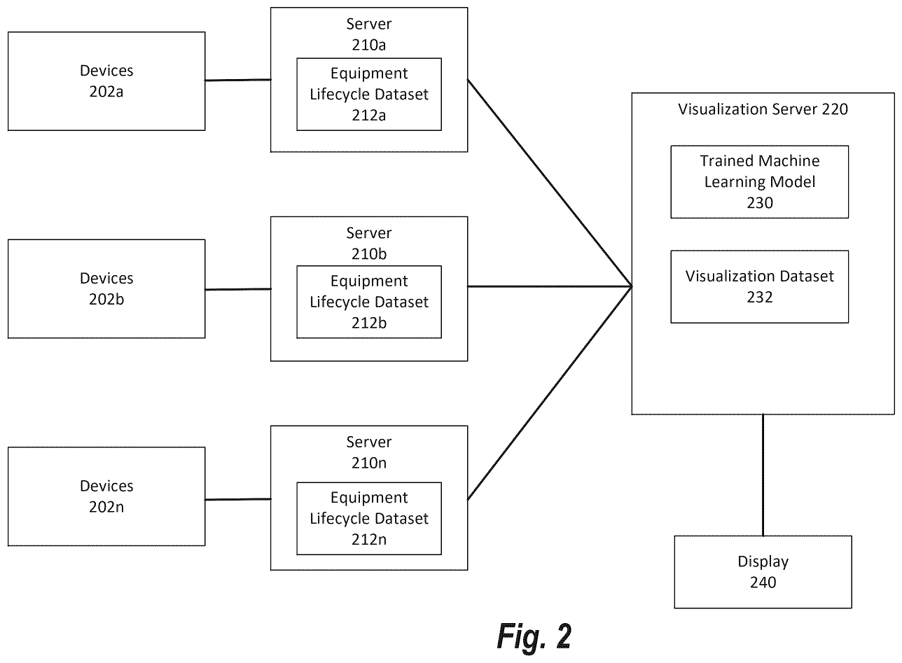

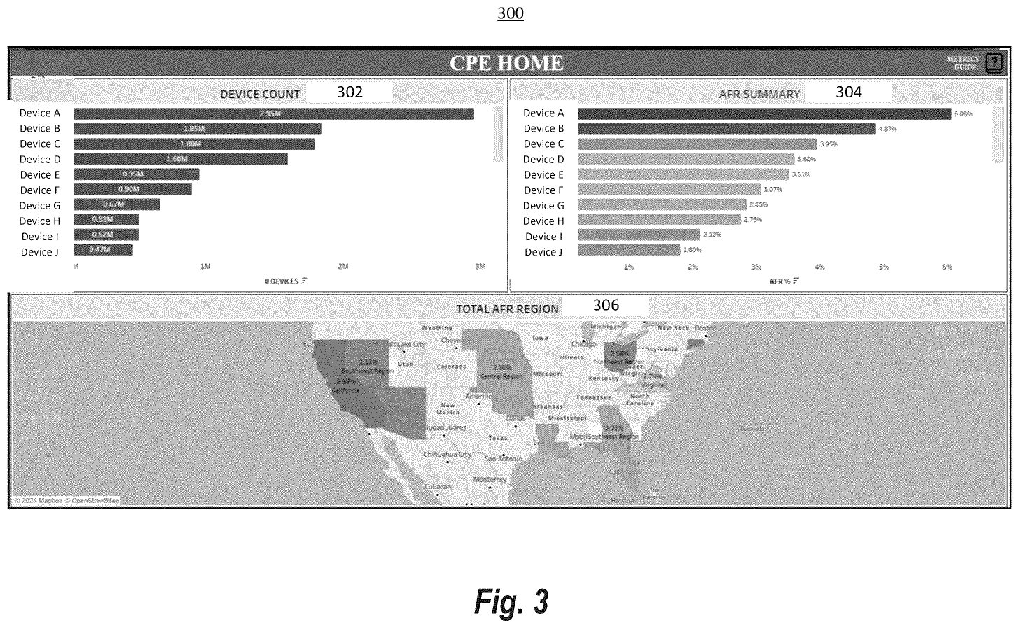

At step 130, the computer-implemented method includes outputting the visualization dataset for display by the display. An example visualization is shown in FIG. 3. The visualization can synthesize equipment lifecycle data 212a, 212b, 212n from any or all of the servers 210a, 210b, 210n as described in greater detail in FIG. 2. An example of data synthesis is combining or consolidating data to create a unified view. Alternatively or additionally, the visualization can include data trends over time, which can optionally include predictions of future trends. A non-limiting example of a data trend can be a rate or likelihood of repair for devices over time. Thus, implementations of the present disclosure can allow for early identification of equipment defects and/or service failures.

As yet another example, the visualization can include a total cost of ownership, which can be based on determining a cost of each event in the equipment lifecycle datasets for each device. If the piece of equipment is a piece of customer equipment (e.g., a cable modem or router), then the equipment lifecycle can include one or more deployments and/or repairs, each of which can represent a cost that is part of an overall total cost of ownership.

Alternatively or additionally, the method can include performing data validation steps to confirm the presence or absence of the anomalies detected at step 120.

With reference to FIG. 2, an example system is shown according to implementations of the present disclosure. The system shown in FIG. 2 can be used to implement any of the methods described with reference to FIG. 1, herein.

The system can include any number of servers 210a, 210b, 210n operably coupled to any number of sets of devices 202a, 202b, 202n. For example, the sets of devices 202a, 202b, 202n can include equipment that is deployed to remote locations (e.g., to customer locations) and is periodically returned to a warehouse or other facility for repair, or between subsequent deployments. The activities of deploying the equipment, repairing equipment, and redeploying the equipment can be part of the “lifecycle” of the devices as described herein. As another non-limiting example, the devices described herein can be modems and/or routers supplied to users of a cable network.

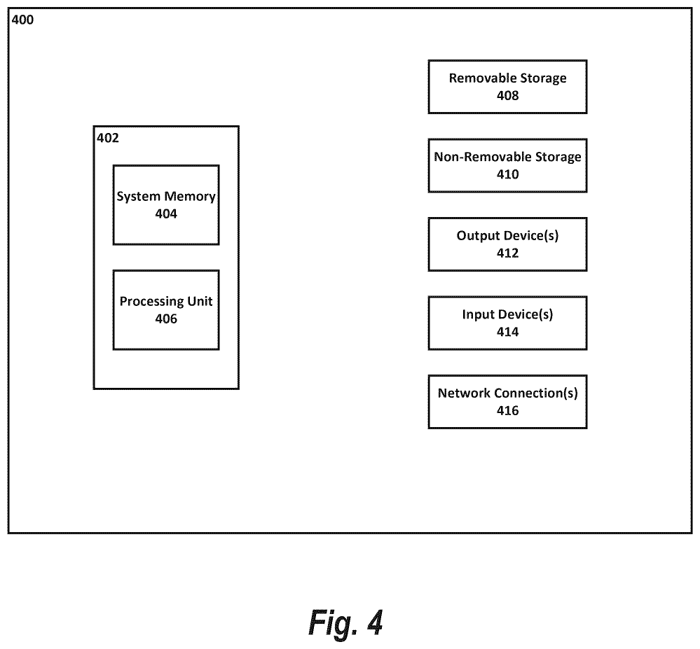

It should be understood that the servers 210a, 210b, 210n can be separate physical servers (e.g., including any or all of the components of the computing device 400 shown in FIG. 4). Alternatively or additionally, any or all of the servers 210a, 210b, 210n can be virtual servers defined within a cloud environment (e.g., parts of a data lake or any other repository for structured or unstructured data).

The servers 210a, 210b, 210n can collect different types of equipment lifecycle data 212a, 212b, 212n depending on the type of devices that are connected and when the devices are connected. For example, one set of servers 210a can be a server related to maintenance or servicing of the devices 202a, another set of servers 210b can be related to monitoring a remote set of devices 202b in customer locations, and yet another set of servers 210n can be related to monitoring another set of devices 202n in storage.

It should also be understood that the devices 202a, 202b, 202n can be the same devices at different points in the lifecycle. For example, set of devices 202a can be devices in a warehouse for repair, set of devices 202b can be devices deployed to customer locations, and set of devices 202n can be devices in storage between deployments to customer locations. The same physical device may therefore be in each of the sets of devices 202a, 202b, 202n at different stages in the device lifecycle.

The system can further include a visualization server 220 operably coupled to the servers 210a, 210b, 210n and to a display 240. The visualization server 220 and servers 210a, 210b, 210n can each include any or all of the components of the computing device 400 described with reference to FIG. 4. The visualization server 220 can be configured to receive the equipment lifecycle datasets 212a, 212b, 212n from the servers 210a, 210b, 210n and extract a visualization dataset 232 for display. The visualization dataset 232 can be transmitted to the display 240 for output. Again, an example visualization is shown in FIG. 3.

Optionally, the visualization server can include a trained machine learning model 230 that can be used to generate the visualization dataset 232. In some implementations, the trained machine learning model 230 can be trained by a hyperparameter tuning technique where the model receives different parameters for seasonality effects and cross-validation is performed with older historical data to train the model. In the cross-validation phase, the hyperparameters with the highest accuracy are selected. Alternatively or additionally, hyperparameter tuning can include using mapgrid optimization. In some implementations, the mapgrid optimization is applied to the forecasting model only.

FIG. 3 illustrates an example visualization 300 of annualized failure rate (AFR) output by an example implementation of the present disclosure. The visualization 300 includes a summary of device counts 302, a summary of annualized failure rate for those devices 304, and a summary of regional annualized failure rates 306.

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by box 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a plurality of servers configured to store a plurality of equipment lifecycle datasets;
a display; and
a visualization server in operable communication with the plurality of servers and the display, wherein the visualization server comprises a processor and a non-transitory memory storing instructions, that, when executed, cause the processor to:
receive the plurality of equipment lifecycle datasets from the plurality of servers;
automatically extract, from the plurality of equipment lifecycle datasets, a visualization dataset; and
output the visualization dataset for display by the display.

2. The system of claim 1, wherein the non-transitory memory further comprises a trained machine learning model.

3. The system of claim 2, wherein the equipment lifecycle datasets comprise purchasing data, deployment data, and repair data for a set of equipment under analysis.

4. The system of claim 2, wherein the machine learning model is a time-series forecasting model.

5. The system of claim 4, wherein the visualization dataset comprises an output of a trained machine learning model.

6. The system of claim 1, wherein the visualization dataset comprises an estimate of lifecycle utilization.

7. The system of claim 1, wherein the visualization dataset comprises an estimate of lifecycle cost of ownership.

8. A computer-implemented method comprising:
receiving a plurality of equipment lifecycle datasets from a plurality of servers;
automatically extracting, from the plurality of equipment lifecycle datasets, a visualization dataset; and
outputting the visualization dataset for display by the display.

9. The computer-implemented method of claim 8, wherein automatically extracting the visualization dataset comprises inputting the plurality of equipment lifecycle datasets into a trained machine learning model.

10. The computer-implemented method of claim 9, wherein the visualization dataset comprises an output of a trained machine learning model.

11. The computer-implemented method of claim 9, wherein the trained machine learning model is a time-series forecasting model.

12. The computer-implemented method of claim 11, wherein the equipment lifecycle datasets comprise purchasing data, deployment data, and repair data for a set of equipment under analysis.

13. The computer-implemented method of claim 8, wherein the visualization dataset comprises an estimate of lifecycle utilization.

14. The computer-implemented method of claim 8, wherein the visualization dataset comprises an estimate of lifecycle cost of ownership.

15. A non-transitory computer readable medium storing instructions thereon, that, when executed by a processor, cause the processor to:
receive a plurality of equipment lifecycle datasets from a plurality of servers;
automatically extract, from the plurality of equipment lifecycle datasets, a visualization dataset; and
output the visualization dataset for display by the display.

16. The non-transitory computer readable medium of claim 15, wherein the non-transitory computer readable medium further comprises instructions that, when executed by the processor, cause the processor to input the plurality of equipment lifecycle datasets into a trained machine learning model.

17. The non-transitory computer readable medium of claim 16, wherein the visualization dataset comprises an output of the trained machine learning model.

18. The non-transitory computer readable medium of claim 16, wherein the trained machine learning model is a time-series forecasting model.

19. The non-transitory computer readable medium of claim 18, wherein the equipment lifecycle datasets comprise purchasing data, deployment data, and repair data for a set of equipment under analysis.

20. The non-transitory computer readable medium of claim 19, wherein the visualization dataset comprises an estimate of lifecycle utilization or lifecycle cost of ownership.
